(19) United States
(12) Patent Application Publication
(10) Pub. No.: US 2010/0082900 A1
(43) Pub. Date: Apr. 1, 2010

(54) MANAGEMENT DEVICE FOR STORAGE DEVICE

(75) Inventors: Koichi MURAYAMA, Kawasaki (JP); Masayasu ASANO, Yokohama (JP)

Correspondence Address: FOLEY AND LARDNER LLP;SUITE 500, 3000 K STREET NW, WASHINGTON, DC, 20007, US

(73) Assignee: HITACHI, LTD.

(21) Appl. No.: 12/276,113

(22) Filed: Nov. 21, 2008

(30) Foreign Application Priority Data
Oct. 1, 2008 (JP) 2008-256780

(51) Int. Cl. G06F 12/00; G06F 12/02; G06F 12/16

(52) U.S. Cl. 711/114; 711/162; 711/171; 711/E12.001; 711/E12.002; 711/E12.103

(57) ABSTRACT

The present invention provides effective use of a storage resource in a system where a storage area of a logical volume is dynamically extended and reduced. In an information processing system including a management device communicably connected to a storage device that can dynamically change a storage capacity of a virtual volume allocated to a host computer, when a used amount of a certain storage pool exceeds a threshold set in the storage pool, the management device sends to the storage device, an instruction to migrate a predetermined number of virtual volumes, sequentially selected in ascending order of capacity increasing rate, so that another storage pool different from the certain storage pool may be used as a creation source. At this time, as a migration destination, the management device uses, the storage pool having, for example, an attribute of the storage resource identical to that of the certain storage device.

### CROSS-REFERENCE TO RELATED APPLICATIONS

The present application claims a priority from Japanese Patent Application No. 2008-256780 filed on Oct. 1, 2008, the content of which herein incorporated by reference.

### BACKGROUND OF THE INVENTION

1. Field of the Invention

The present invention relates to a management device for a storage device, and particularly, relates to a technique for aiming at effective use of storage resources in a storage system that provides a virtual volume based on a storage pool.

2. Related Art

Japanese Patent Application Publication No. 2003-015915 describes a storage system in which a volume providing device dynamically extends a storage area of a logical volume. More specifically, the volume providing device receives an I/O request from a host computer to access the logical volume, reads a logical block address to be accessed by the I/O request, and allocates the storage area from an unused disk storage when the storage area indicated by the logical block address to be accessed by the I/O request does not exist in the logical volume.

Japanese Patent Application Laid-open Publication No. 2003-015915 also teaches that the volume providing device receives a reduction request of the logical volume from the host computer, reads the logical block address targeted by the reduction request, and reduces the storage area of the logical block address specified by the reduction request.

When aiming at effective use of storage resource in the system in which the storage area of the logical volume are dynamically extended and reduced as mentioned above, for example, a user frequently monitors a use status of the storage area allocated to the host computer, and re-allocates the storage area to the host computer when needed.

However, such monitoring and re-allocation need complicated operations, thereby placing a heavy burden on the user. Additionally, in the re-allocation, it is necessary to consider specifications of the system, restrictions on operation, or the like. For this reason, an increase in size of the system causes increase in management burden on the system or management costs of the system.

### SUMMARY OF THE INVENTION

The present invention has been made in view of such a background. An object of the present invention is to provide a management device for a storage device for implementing effective use and efficient management of storage resources in a system in which a storage area of a logical volume is dynamically extended and reduced.

One aspect according to the present invention for attaining the above-mentioned object is a management device coupled to the storage device that provides a virtual volume using one storage pool of a plurality of storage pools as a creation source; the management device includes a storage management unit that sends a migration instruction to the storage device in case that a used amount of a certain one of the storage pools exceeds a threshold set in the certain storage pool in such a manner that a predetermined number of the virtual volumes sequentially selected in ascending order of capacity increasing rate are migrated to another one of the storage pools that is different from the certain storage pool using as a creation source, in which the storage management unit uses, as the other storage pool, a storage pool that is formed of a storage resource whose attribute is identical to that of the certain storage pool currently used as the creation source for the virtual volume to be migrated, and that satisfies a condition that the used amount of the storage pool does not exceed a threshold set in advance after executing the migration; in case that none of the other storage pools satisfies the condition, the storage management unit newly creates a storage pool satisfying the condition and uses the created new storage pool as the other storage pool; and the storage management unit sends the instruction to the storage device when the instruction is within the range of a restriction imposed on the storage pool in the storage device.

Besides, problems disclosed in this application and solutions thereof will be clarified with the section of the detailed description of the invention and the drawings.

According to the present invention, in a system in which a storage area of a logical volume is dynamically extended and reduced, effective use and efficient management of a storage resource can be achieved.

### BRIEF DESCRIPTION OF THE DRAWINGS

FIG. 1 is a diagram showing a schematic configuration of an information processing system 1;

FIG. 2A is a diagram showing hardware of a storage device 10;

FIG. 2B is a diagram showing an example of hardware of a management device 20, a host computer 30, and a management client device 40;

FIG. 3A is a diagram showing a function of the management device 20 and data managed by the management device 20;

FIG. 3B is a diagram showing a function of the storage device 10;

FIG. 3C is a diagram illustrating a supply form of a storage area from the storage device 10 to the host computer 30;

FIG. 4 is an explanatory view showing an example of a volume management table 21;

FIG. 5 is a diagram showing an example of a pool management table 22;

FIG. 6 is a diagram showing an example of a pool use history management table 23;

FIG. 7 is a flow chart illustrating a processing on creation of a virtual volume 1442;

FIG. 8 is a flow chart illustrating a processing on deletion of the virtual volume 1442;

FIG. 9 is a sequence diagram illustrating a sequence of a maintenance processing of a pool with increase in a used amount;

FIG. 10 is a flow chart illustrating details of a processing of the management device 20 in the maintenance processing of the pool shown in FIG. 9;

FIG. 11 is a diagram showing an example of a pool restriction management table 24;

FIG. 12 is a flow chart illustrating the maintenance processing of the pool in consideration of the restriction of the pool; and

FIG. 13 is a flowchart illustrating a processing to reduce a storage area of a pool 143 having a large unused area.

### DETAILED DESCRIPTION OF THE INVENTION

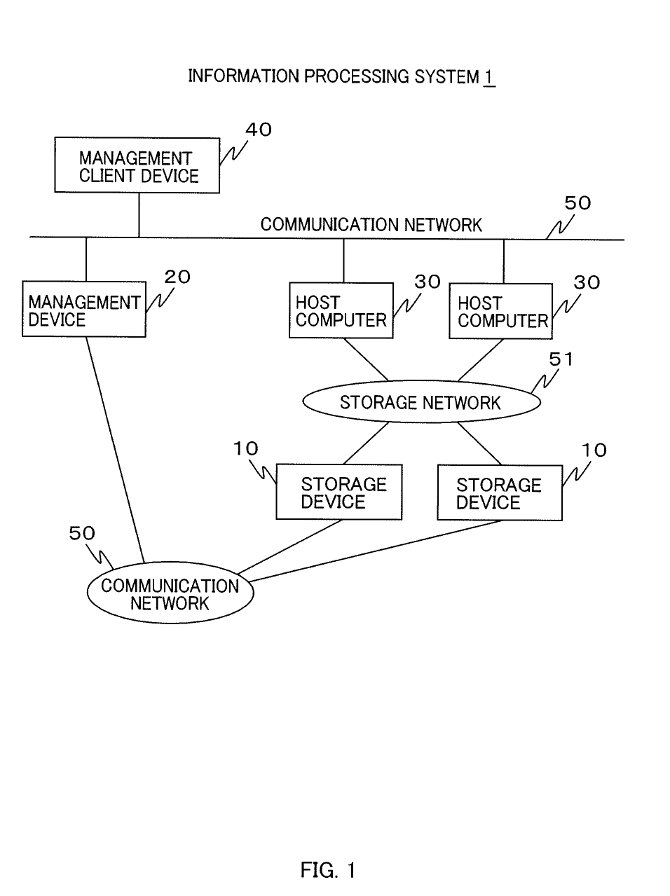

Hereinafter, embodiments will be described with reference to the drawings. FIG. 1 shows a schematic configuration of an information processing system 1 described as an embodiment. The information processing system 1 is configured to include a storage device 10, a management device 20, a host computer 30, and a management client device 40. Each of these devices is communicably connected to one another through a communication network 50, such as a Local Area Network (LAN). The host computer 30 and the storage device 10 are connected to the storage device 10 through a storage network 51, such as a Storage Area Network (SAN).

Note that, although FIG. 1 shows two storage devices 10, one management device 20, two host computers 30, and one management client device 40, the number of each device will not be limited to this. The storage network 51 performs communications in accordance with communications protocols, such as a Fibre Channel and an internet Small Computer System Interface (iSCSI), for example.

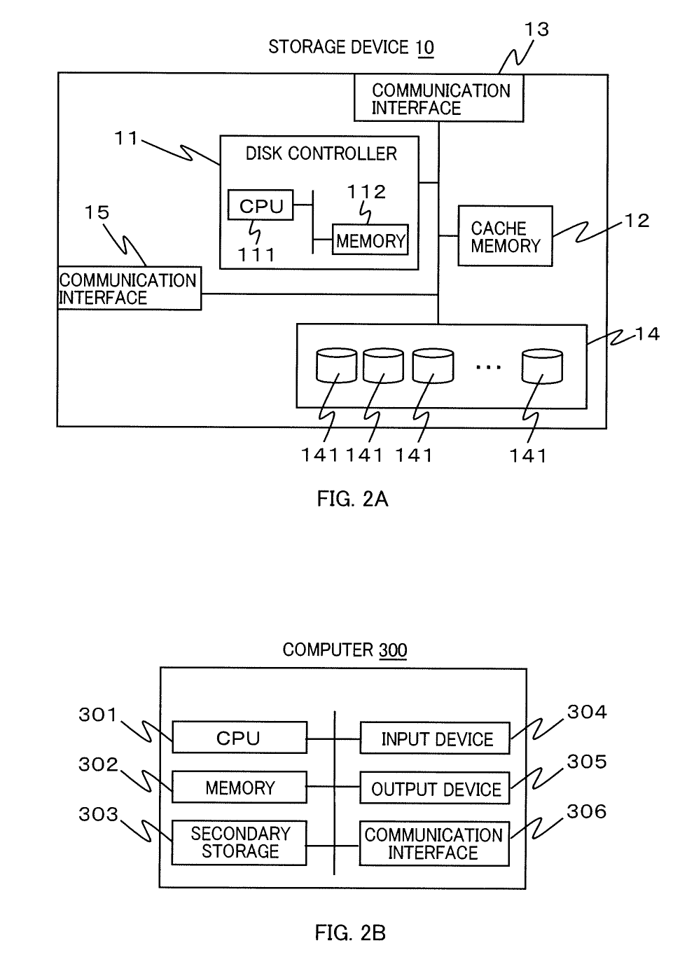

FIG. 2A shows hardware of the storage device 10. As shown in the drawing, the storage device 10 includes a disk controller 11, a cache memory 12, a communication interface 13 for connection to the storage network 51, a disk unit 14, and a communication interface 15 for connection to the communication network 50.

In these, the disk controller 11 includes a CPU 111 and a memory 112, and executes a processing for implementing a function of the storage device 10. In the cache memory 12, for example, data written in the disk unit 14 and data read from the disk unit 14 are stored. The disk unit 14 includes one or more hard disk drives 141 (physical disk).

The disk unit 14 may be controlled by a method of Redundant Arrays of Inexpensive (or Independent) Disks (RAID) (RAID0-RAID6). Each hard disk drive 141 has an attribute (for example, storage capacity, interface type (a Serial AT attachment (SATA), a Fibre Channel (FC), a Serial Attached SCSI (SAS), performance (revolution per minute (rpm), transfer rate, average seek time, average search time, etc.)). The storage medium of the storage device 10 is not limited to the hard disk drive 141. For example, the storage medium maybe semiconductor memories (a Solid State Drive (SSD), etc.).

Note that the storage device 10 may be formed of a plurality of pieces of hardware, the pieces of hardware having a different housing. Hardware of different models and hardware of different vendors may coexist in this case. As a specific example of the storage device 10, a disk array device includes a channel controller that communicates with the host computer 30; a disk controller that accesses the hard disk drive; a cache memory used to pass data between the channel controller and the disk controller, or the like; and a communication mechanism, such as a switch, which communicably connects each unit of the device.

Each of the management device 20, the host computers 30, and the management client devices 40 shown in FIG. 1 is a computer (information apparatus). FIG. 2B shows an example of hardware of the computer used as these devices. The computer 300 shown in the drawing includes a CPU 301; a memory 302 that is a volatile or nonvolatile storage device (for example, a Random Access Memory (RAM) and a Read Only Memory (ROM)); a secondary storage 303 (for example, hard disk); an input device 304 (for example, keyboard and mouse) that receives an input of operation from a user; an output device 305 (for example, liquid crystal display monitor); and a communication interface 306 (for example, a Network Interface Card (NIC) or a Host Bus Adapter (HBA)) that allows communication with other devices.

Note that each of the management device 20, the host computer 30, and the management client device 40 may be formed of a plurality of the computers 300. The management device 20 may be integrated with the storage device 10. Either of the management device 20 and the management client device 40 may have both functions of the management device 20 and the management client device 40.

The host computer 30 uses a logical volume provided by the storage device 10 as a data storage area. The host computer 30 executes a DataBase Management System (DBMS) that provides services for the user, a backup program, or the like, thereby implementing various kinds of functions (services). The host computer 30 writes the data used by these functions, in the storage device 10, or reads the data from the storage device 10.

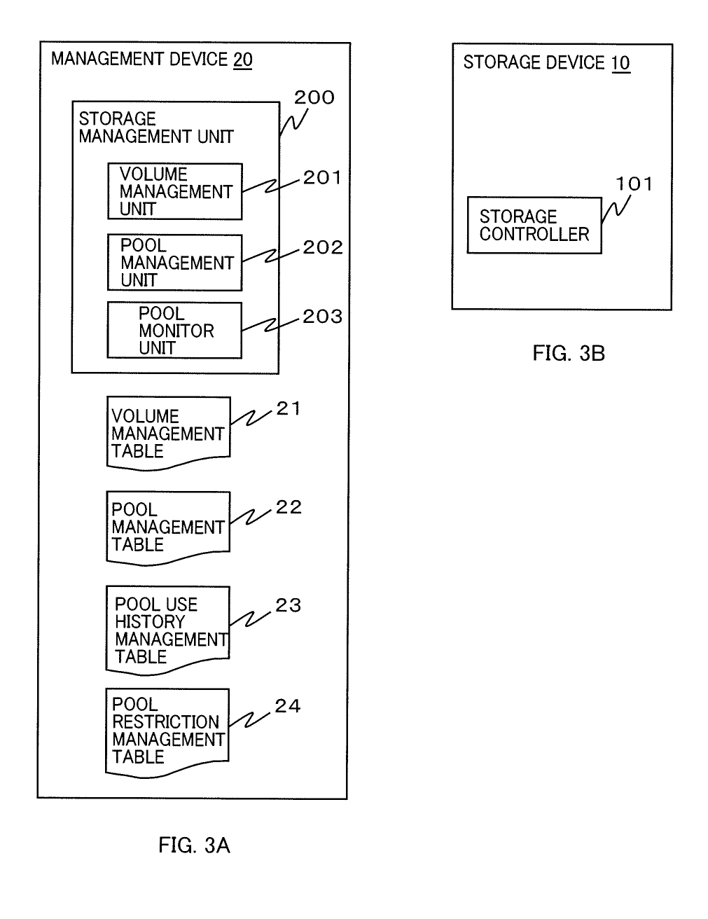

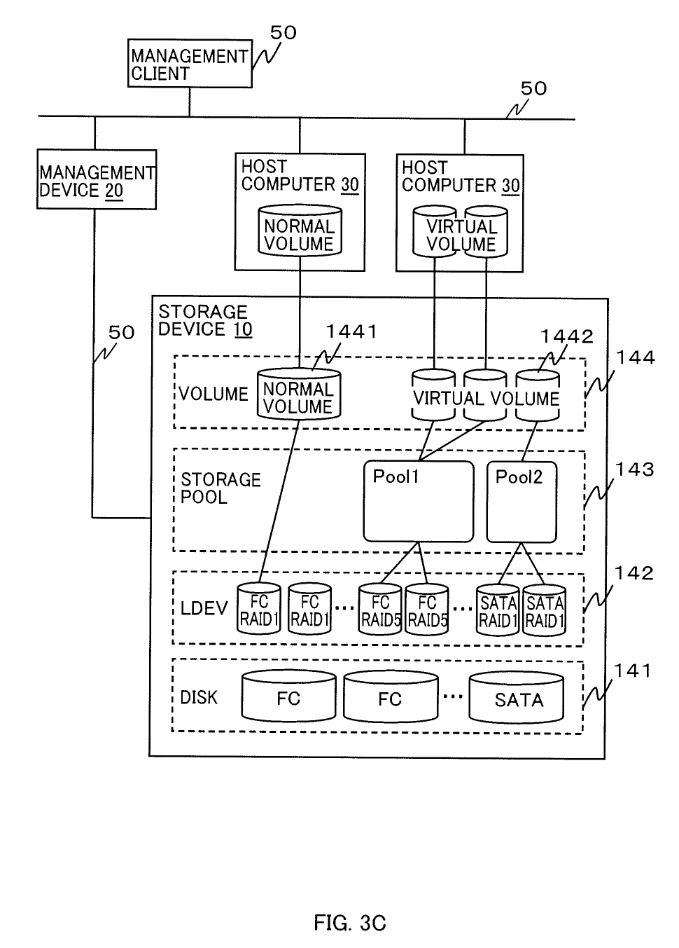

FIG. 3A shows functions of the management device 20 and data managed by the management device 20. Note that each of the functions shown in the drawing is implemented in a way that the CPU 301 of the management device 20 executes a program read to the memory 102, or implemented by hardware of the management device 20. The implementation of the above-mentioned functions may involve functions implemented by other software such as an operating system or a device driver which operates in the management device 20.

In the drawing, in accordance with a request from the management client device 40, the storage management unit 200 manages the storage device 10 through a storage controller 101 that is a function of the storage device 10 to be described later. As shown in the drawing, the storage management unit 200 includes functions of a volume management unit 201, a pool management unit 202, and a pool monitor unit 203.

The volume management unit 201 provides various management functions on the logical volume, such as creation and deletion of the logical volume, allocation of the logical volume to the host computer 30, migration (migration within the same pool 143 and between different pools 143) of the logical volume (normal volume 1441 or virtual volume 1442 described later), replication of the logical volume within the same storage device 10, and replication of the logical volume between the storage devices 10. The volume management unit 201 also manages a volume management table 21 described later.

The pool management unit 202 manages a storage pool (hereinafter, referred to as a pool 143) described later, in accordance with a request from the management client device 40. For example, the pool management unit 202 sends a creation request of the pool 143 or a deletion request of the pool 143 to the storage device 10 in accordance with the request from the management client device 40. Note that information (identifier) that identifies the pool 143 to be created or deleted is attached to the creation request or deletion request of the pool 143. The pool management unit 202 also manages a virtual volume 1442 described later. For example, in response to a request from the management client device 40, to the storage device 10, the pool management unit 202 sends a creation or deletion request of the virtual volume 1442, or an allocation request of the virtual volume 1442 to the host computer 30 or an allocation release request of the virtual volume 1442 from the host computer 30. Information (identifier) that identifies the virtual volume 1442 that is a target of the request and the pool 143 to which the virtual volume 1442 belongs is attached to these requests. The pool management unit 202 also manages a pool management table 22 described later.

The pool monitor unit 203 monitors a storage capacity and usage rate of the pool 143, and notifies the management client device 40 of an alert. The pool monitor unit 203 monitors a state of the pool 143 of each storage device 10 on the management device 20, and reflects the result in a pool use history management table 23.

The management client device 40 includes a Graphical User Interface (GUI) and a Command Line Interface (CLI) for presenting a result executed by the storage management unit 200 to the user. The management client device 40 requests a processing of the management device 20 in response to an instruction received from the user.

In response to a request by the management device 20, the storage device 10 forms the virtual volume 1442 using a specified pool 143 as a creation source. The storage device 10 also allocates the virtual volume 1442 to the host computer 30 in response to a request by the management device 20. Note that the virtual volume 1442 is given information (an identifier) for identifying the virtual volume 1442. By used of this identifier, the host computer 30 accesses the virtual volume 1422. Moreover, when writing is to be performed onto an address in the virtual volume 1422 to which a later-described LDEV 142 (Logical Device) is not allocated, the storage device 10 newly allocates a part of a storage area of the LDEV 142 to the address.

FIG. 3B shows a function of the storage device 10. A storage controller 101 is implemented in a way that the CPU 111 of the storage device 10 executes a program read in the memory 112, or is implemented by hardware included in the storage device 10. Note that the implementation of the above-mentioned function may involve functions implemented by other software such as the operating system and device driver that operate in the storage device 10.

In accordance with a request from the management device 20, the storage controller 101 executes, such as creation and deletion of the logical volume, allocation of the logical volume to the host computer 30, creation and deletion of the pool 143, creation and deletion of the virtual volume 1442, allocation of the virtual volume 1442 to the host computer 30 or allocation release of the virtual volume 1442 from the host computer 30, migration of the logical volume, and replication of the logical volume within the storage device 10 or between the storage devices 10. Moreover, the storage controller 101 manages thresholds of various kinds described later set by the management device 20, the host computer 30, the management client device 40, or the user.

FIG. 3C shows a supply form of the storage area from the storage device 10 to the host computer 30. As shown in the drawing, the LDEV 142 is provided, the LDEV 142 being a logical storage area (storage resource) formed by the disk unit 14 of the storage device 10 using the storage area of one or more hard disk drives 141. Each LDEV 142 has attributes, which are information on a specification of the LDEV 142 such as a configuration, performance, reliability of each LDEV 142, including a level of RAID, and a type or model number of an interface of the hard disk drive 141 that forms the LDEV 142.

The storage device 10 provides the host computer 30 with the logical volume 144 that is a logical storage area formed using the storage area of one or more LDEVs 142. When the data is written in the logical volume 144, the data is written in the disk unit 14 that forms the LDEV 142, which forms the logical volume 144.

Here, the logical volume 144 includes a normal volume 1441 and a virtual volume 1442. The former normal volume 1441 is the logical volume 144 to which the LDEV 142 that provides the storage area of the normal volume 1441 is fixed. On the other hand, the latter virtual volume 1442 is the logical volume 144 to which the LDEV 142 that provides the storage area of the virtual volume 1442 is not fixed. The storage capacity and attribute of the virtual volume 1442 can be changed during operation corresponding to a use status of the virtual volume 1442 and needs. The storage area of the virtual volume 1442 is provided by a plurality of pools 143 formed by one or more LDEVs 142. Thus, the storage device 10 provides the storage area in units of the virtual volume 1442 to the host computer 30. Thereby, corresponding to each use status, the storage resource can be appropriately allocated to the host computer 30, and the storage resource can be effectively utilized. Additionally, when the storage device 10 is formed of a plurality of pieces of hardware of different models or different vendors, data migration and replication between different models and between multi vendors become possible.

### <Description of Tables>

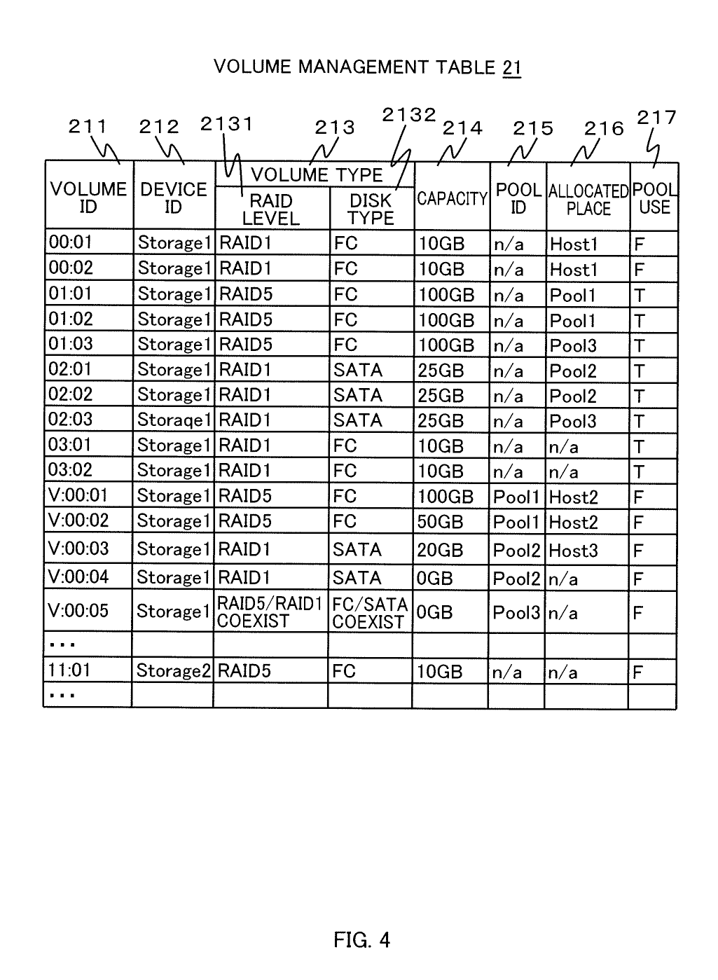

FIG. 4 shows an example of the volume management table 21 managed by the management device 20. In the volume management table 21, information on the LDEV 142 and the virtual volume 1442 is registered. The volume management table 21 has a plurality of records that include each item of a volume ID 211, a device ID 212, a volume type 213, a storage capacity 214, and a pool ID 215, an allocated place 216, and pool use 217.

In the volume ID 211, an identifier (volume ID) that identifies the LDEV 142 or the virtual volume 1442 is set. When the record is a record of the LDEV 142, the identifier (LDEV-ID) of the LEDV 142 is set. When the record is a record of the virtual volume 1442, the identifier (virtual volume ID) of the virtual volume 1442 is set.

In the device ID 212, the identifier (storage ID) of the storage device 10 that provides the LDEV 142 or the virtual volume 1442 is set. As the storage ID, for example, a combination of an identifying name registered by the user, a model number and model name of the storage device 10, and an IP address given to the storage device 10 is used.

The volume type 2113 includes a RAID level 2131 and a disk type 2132. In these, in the RAID level 2131, the RAID level of a physical disk that forms the LDEV 142 or the virtual volume 1442 is set. In the case of the LDEV 142, the RAID level of the LDEV 142 is set. In a case of the virtual volume 1442, the RAID level of the LDEV142 that forms the pool 143 of the creation source of the virtual volume 1442 is set.

When the pool 143 of the creation source of one virtual volume 1442 is formed by a plurality of LDEVs 142 that belong to different RAID groups, the RAID levels of all the LDEVs 142 that form the pool 143 are set in the volume type 2113. For example, when the pool 143 is formed by the LDEV 142 of RAID5 and the LDEV 142 of RAID1, “RAID5” and “RAID1” are set in the RAID level 2131 of the virtual volume 1442 whose creation source is the pool 143.

In the disk type 2131, the type of the hard disk drive 141 that provides the storage area of the LDEV142 or the virtual volume 1442 is set. In other words, in the case of the LDEV 142, the type of the hard disk drive 141 that forms the LDEV 142 is set. In the case of the virtual volume 1442, the type of the hard disk drive 141 that forms the LDEV 142, which forms the pool 143 that is the creation source of the virtual volume 1442, is set.

When the pool 143 of the creation source of one virtual volume 1442 is formed of a plurality of LDEVs 142 that belong to different RAID groups, the RAID levels of all the LDEVs 142 that form the pool 143 are set in the disk type 2131. For example, when the pool 143 is formed by the LDEV 142 formed using the hard disk drive 141 having the type of “FC,” and by the LDEV142 formed using the hard disk drive 141 having the type of “SATA,” “FC” and “SATA” are set in the disk type 2131 of the virtual volume 1442 whose creation source is the pool 143.

Note that, while FIG. 4 shows a case where the storage medium of the disk unit is the hard disk drive 141, for example, “SSD” is set in the disk type 2131 when the storage medium is a semiconductor memory (SSD). Moreover, while the drawing shows the RAID level 2131 and the disk type 2132 as the content of the volume type 213, the volume type 213 may include, for example, items on performance and reliability of the storage medium, such as the rpm of the hard disk drive 141, and reliability of the hard disk drive 141.

In the storage capacity 214, the storage capacity of the LDEV 142 or the virtual volume 1442 is set. In the case of the LDEV142, the storage capacity of the LDEV142 is set. In the case of the virtual volume 1442, the current storage capacity allocated to the virtual volume 1442 from the pool 143 is set.

In the pool ID 215, the identifier (pool ID) of the pool 143, to which the virtual volume 1442 belongs when the record is a record of the virtual volume 1442, is set. When the record is a record of the LDEV 142, such as “n/a” is set in the pool ID 215.

Information that indicates the allocated place of the LDEV 142 or the virtual volume 1442 is set in the allocated place 216. For example, when one LDEV 142 is used as the normal volume 1441 and the normal volume 1441 is allocated to the host computer 30, the identifier (host ID) of the host computer 30 of the allocated place is set. Moreover, when one LDEV 142 is used as the pool 143, the pool ID of the pool 143 using the LDEV 142 is set in the allocated place 216. When one LDEV 142 is allocated to neither the host computer 30 nor the pool 143, “n/a” is set in the allocated place 216.

For example, when the LDEV 142 whose volume ID 211 is “00:01” is allocated to the host computer 30 whose host ID is “Host1” as the normal volume 1441, “Host1” is set in the allocated place 216. Further, when the LDEV 142 whose volume ID 211 is “01:01” is allocated to the pool 143 whose pool ID is “Pool1”, “Pool1” is set in the allocated place 216.

Information is set in the pool use 217, the information indicating whether the LDEV 142 can be used as the pool 143 when the record is a record of the LDEV 142. When the LDEV 142 can be used as the pool 143, “T” is set as the pool use 217. When the LDEV 142 cannot be used as the pool 143, “F” is set as the pool use 217. An example when “F” is set includes a case where the storage device 10 that provides the LDEV 142 does not originally include a function needed to provide the virtual volume 1442; a case where the LDEV 142 is already allocated to the host computer 30 as the normal volume 1441; and a case where the record is a record of the virtual volume 1442.

When the RAID group is formed by the disk 141 of the disk unit 14 and the LDEV 142 is created, the volume management unit 201 registers the record corresponding to the LDEV 142 in the volume management table 21. When the virtual volume 1442 is created, the volume management unit 201 registers the record corresponding to the virtual volume 1442 in the volume management table 21. When the LDEV 142 or the virtual volume 1442 is deleted, the volume management unit 201 deletes the record from the volume management table 21.

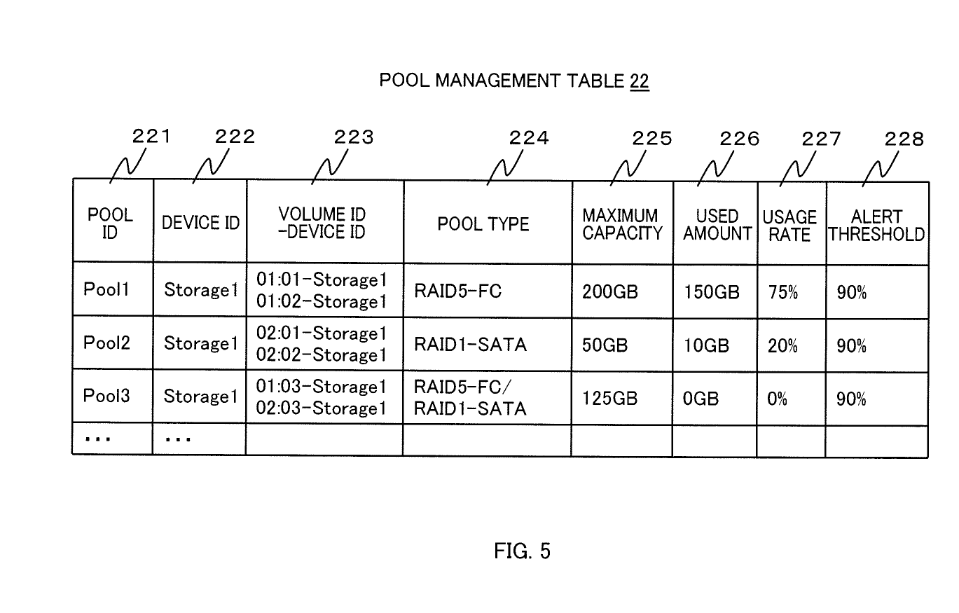

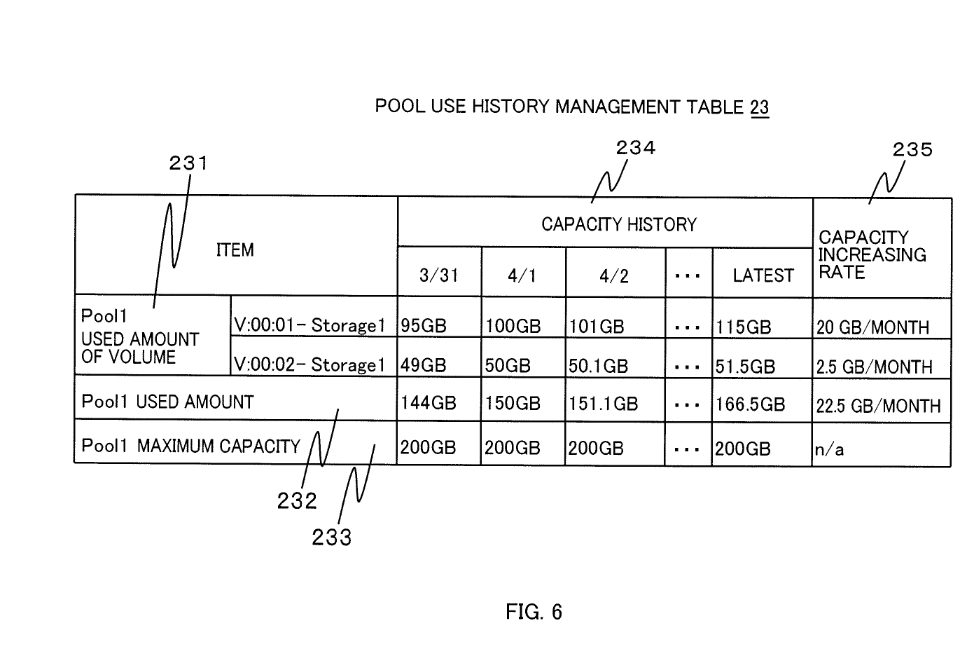

FIG. 5 shows an example of the pool management table 22 that the management device 20 manages. In the pool management table 22, information on the pool 143 provided by the storage device 10 is managed. As shown in the drawing, the pool management table 22 has a plurality of records that include a pool ID 221, a device ID 222, a volume ID-device ID 223, a pool type 224, a maximum capacity 225, a used amount 226, a usage rate 227, and an alert threshold 228.

An identifier (pool ID) for uniquely identifying the pool 143 is set in the pool ID 221. The pool ID is assigned to the storage device 10, for example, when creating the pool 143.

An identifier (storage ID) of the storage device 10 that provides the pool 143 is set as the device ID 222.

An ID (LDEV ID) of the LDEV 142 that forms the pool 143 is set as the volume ID-device ID.

The type of the LDEV 142 that forms the pool 143 is set as the pool type 224. When the LDEV 142 that forms the pool 143 has one type, the type of the LDEV 142 is connected by using a symbol “-” and set. For example, “RAID5-FC” is set when the LDEV 142 that forms the pool 143 is “RAID5” and “FC.”

When the LDEV 142 that forms the pool 143 has a plurality of types, all types of each LDEV 142 are set. For example, when the pool 143 is formed of the LDEV 142 whose type is “RAID5” and “FC,” and of the LDEV 142 whose type is “RAID1” and “SATA,” the type is set like “RAID5-FC/RAID1-SATA.”

The maximum storage capacity of the virtual volume 1442 that can be created from the pool 143 is set in the maximum capacity 225. When the pool 143 is formed of a plurality of LDEVs 142, a total of the storage capacity of each LDEV 142 that forms the pool 143 is set.

In the used amount 226 (allocated amount), a total of the capacity of the storage area where the data is already written in among the LDEVs 142 that form the pool 143 is set.

A proportion of the current used amount to the maximum storage capacity of the pool 143 is set in the usage rate 227 (allocated rate). More specifically, the usage rate 227 is set to have a value obtained from the used amount/maximum storage capacity×100(%).

A threshold is set in the alert threshold 228, the threshold being referred to when determining whether a danger that capacity extension of the virtual volume 1442 may be impossible is increased due to the higher usage rate of the pool 143. The management device 20 notifies the user or the management client device 40 of the alert by comparing a value of the usage rate 226 and this threshold. Thereby, capacity extension of the pool 143, migration of the virtual volume 1442, etc. are automatically or manually performed.

Note that, while the alert threshold 228 is set to be 90% in FIG. 5, the user interface for setting the threshold may be provided so that the user can set the threshold. Further, a plurality of thresholds depending on a stage may be set in order to issue the alert stage-by-stage. While the threshold is set for each pool 143 in FIG. 5, it is not necessary to set the threshold in units of the pool 143, and the user may set the threshold in arbitrary units, such as setting the threshold in units of a plurality of pools 143.

When the pool 143 is created in the storage device 10, the pool management unit 202 newly registers the record in the pool management table 22. On the other hand, when the pool 143 is deleted, the pool management unit 202 deletes the record from the pool management table 22. When the LDEV 142 that forms one pool 143 is added, the pool management unit 202 refers to the volume management table 21 for the pool 143, sets information on the LDEV 142 added to the volume ID-device ID 223 of the pool 143, and adds the storage capacity of the LDEV 142 added to the maximum storage capacity 225 to reset a value re-calculated as the usage rate 226. Moreover, when the pool type 224 of the pool 143 is not included in the volume type 213 of the added LDEV 142, the pool management unit 202 adds the volume type 213 of the LDEV 142 added to the pool type 224. On the other hand, when the LDEV 142 is deleted from the pool 143, the pool management unit 202 performs a processing opposite to the case where the LDEV142 is added, and correctly updates the pool management table 22.

FIG. 6 shows an example of the pool use history management table 23 that the management device 20 manages. Note that, while this pool use history management table 23 shows only information on “Pool1,” the management device 20 manages the pool use history management table 23 for every pool 143 registered in the pool management table 22.

In the pool use history management table 23, the use history of the pool 143 provided by each storage device 10 managed by the storage management unit 200 is managed. As shown in the drawing, in the pool use history management table 23, the storage capacity at each point within a predetermined period (capacity history 234) is recorded with respect to an used amount 231 of each LDEV 142 that forms the pool 143, an used amount 232 of the pool 143, and a maximum storage capacity 233 of the pool 143. As shown in the drawing, with respect to the used amount 231 of each LDEV 142 that forms the pool 143 and the used amount 232 of the pool 143, an increasing rate 235 of the storage capacity for the predetermined period is also recorded. While the data for the past one month is registered day by day in the case of the pool use history management table 23 shown in the drawing, another frequency or another period may be used.

The pool monitor unit 203 monitors a state of the pool 143 provided by the storage device 10 managed by the storage management unit 200, and reflects the latest state of the pool 143 in the pool use history management table 23. Note that deletion of data before the predetermined period is also carried out if needed. The pool monitor unit 203 refers to the pool management table 22, and when the used amount of the pool 143 exceeds the threshold, the pool monitor unit 203 calls the pool management unit 202 to perform automatic extension of the pool 143. Moreover, the pool monitor unit 203 calls the volume management unit 201 to carry out migration of the virtual volume 1442.

### =Description of Processing=

Hereinafter, a processing performed in an information processing system 1 will be described.

### <Creation of Virtual Volume>

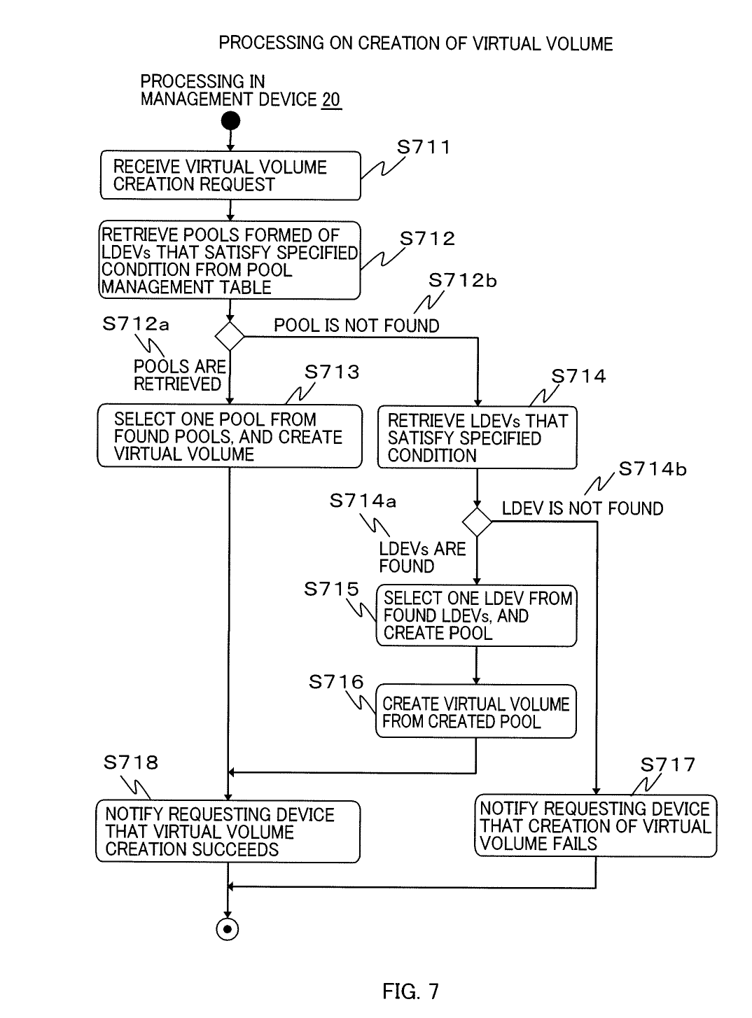

FIG. 7 is a flow chart illustrating a processing on creation of the virtual volume 1442. In the following description, character “S” given before numerals is an abbreviation of step.

When creating the virtual volume 1442, the user operates the management client device 40, and instructs to create the virtual volume 1442. Thereby, a request for creation of the virtual volume 1442 is sent from the management client device 40 to the management device 20. Note that, in the request for creation to be sent, conditions (hereinafter, referred to as specified condition), such as the storage capacity of the virtual volume 1442 to be created, the RAID level, and the type and rpm of the HDD, are attached thereto.

When the volume management unit 201 of the management device 20 receives the request for creation of the virtual volume 1442 from the management client device 40 (S711), the volume management unit 201 of the management device 20 retrieves the pools 143, which are formed using the LDEV 142 that satisfies the specified condition attached to the request for creation, from the pool management table 22 (S712). When the pools 143 that satisfy the specified condition exist (S712a), the volume management unit 201 selects one of the pools 143, and requests the storage device 10 that provides the pool 143 to create the virtual volume 1442 (S713). When the storage controller 101 of the storage device 10 receives the above-mentioned request for creation, in response to this, the storage device 10 creates the virtual volume 1442, and sends a completion notification to the management device 20 after completion of creation.

When receiving the completion notification from the storage device 10, the volume management unit 201 registers the record corresponding to the created virtual volume 1442 in the volume management table 21. For example, when the virtual volume 1442 having a volume ID “V:00:01” is created using the pool 143 that is provided by the storage device 10 having a device ID “Stroage1” and has the pool ID “Pool1” as the creation source, the volume management unit 201 registers the record in the volume management table 21, in which the volume ID 211 is “V:00:01” the device ID 212 is “Storage1,” the RAID level 2131 is “RAID5,” the disk type 2132 is “FC,” the storage capacity 214 is “0 GB,” the pool ID 215 is “Pool1,” the allocated place 216 is “n/a,” and the pool use T 217 is “F.” The content of the RAID level 2131 is acquired, for example, from the pool type 224 in the record of the pool 143 of the creation source of the pool management table 22. Subsequently, the processing goes to S718.

On the other hand, when the pool 143 that satisfies the specified condition is not found at S712 (S712b), the volume management unit 201 retrieves the LDEV 142 from the volume management table 21 (S714), the LDEV 142 satisfying the specified condition, having “n/a” set as the allocated place 216, and “T” set as the pool use 217.

When the LDEVs 142 that satisfy the specified condition are found (S714a), the volume management unit 201 selects one LDEV 142 from the LDEVs 142 found, and creates a new pool 143 using the selected LDEV 142 (S715). Then, the volume management unit 201 registers the record corresponding to the created new pool 143 in the pool management table 22.

For example, when the LDEV 142 used to create the pool 143 has the volume ID of “03:01,” the storage capacity of “2 GB,” the device ID of “Storage3,” and the new given pool ID of “3,” the volume management unit 201 newly registers the record in the pool management table 22, in which the pool ID 221 is “Pool3,” the device ID 222 is “Storage3,” the volume ID-device ID 223 is “03:01-Storage3,” the pool type 224 is “RAID5-FC” (from the type of the LDEV 142 of the creation source), the maximum storage capacity 225 is “2 GB,” the used amount 226 is “0 GB,” the usage rate 227 is “0%,” and the alert threshold 228 is “90%.” The content of the pool type 224 is acquired from the volume type 213 of the LDEV 142 in the volume management table 21, the LDEV 142 being used to create the pool 143.

When the pool 143 is newly created as mentioned above, the volume management unit 201 sends a next request for creation of a new virtual volume 1442 to the storage device 10 using a new pool 143 as the creation source (S716). When the storage device 10 receives the request for creation, in response to this, the storage device 10 creates the virtual volume 1442. When the volume management unit 201 receives the completion notification from the storage device 10, the volume management unit 201 registers the record corresponding to the created virtual volume 1442 in the volume management table 21.

After creation of the virtual volume 1442, the volume management unit 201 notifies the management client device 40 that creation of the virtual volume 1442 is successful (S718), and the processing terminates.

Note that, when the LDEV 142 that satisfies the specified condition is not found at S714 (S714b), the volume management unit 201 notifies the management client device 40 that the virtual volume 1442 that satisfies the specified condition cannot be created (S717), and the processing terminates.

With the above-mentioned processing, the virtual volume 1442 that satisfies the conditions specified by the user can be created. In addition, with creation of the virtual volume 1442, the pool 143 can be automatically created when needed.

### <Deletion of Virtual Volume>

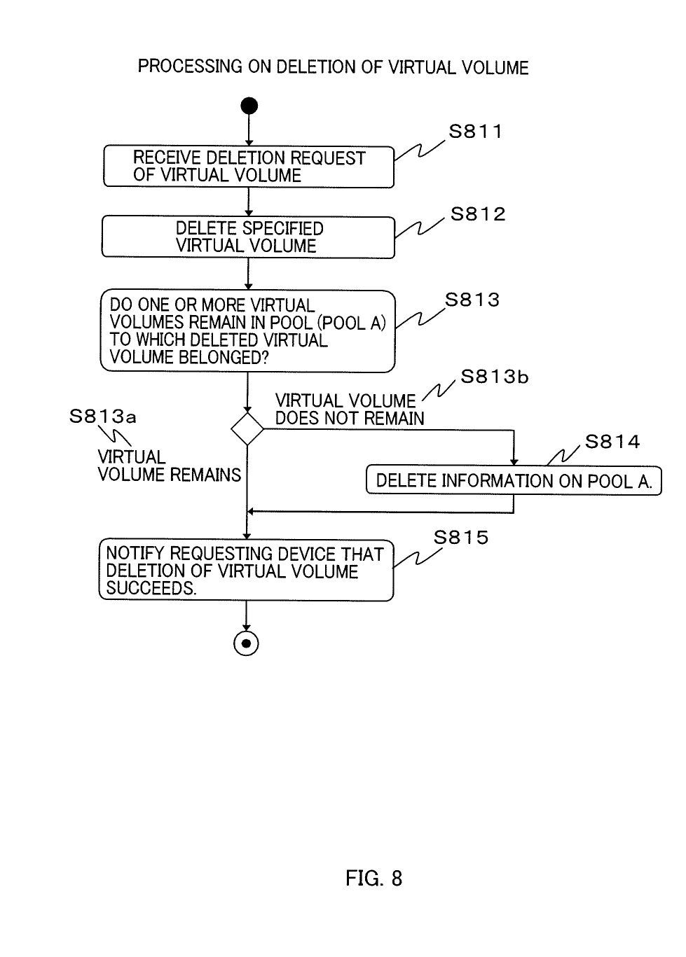

FIG. 8 is a flow chart illustrating a processing on deletion of the virtual volume 1442. When deleting the virtual volume 1442, the user operates the management client device 40 and instructs to delete the virtual volume 1442. Thereby, a request for deletion of the virtual volume 1442 is sent from the management client device 40 to the management device 20. Note that, in the request for deletion to be sent, the information (virtual volume ID) that specifies the virtual volume 1442 to be deleted is attached thereto.

When the volume management unit 201 of the management device 20 receives the request for deletion of the virtual volume 1442 from the management client device 40 (S811), the volume management unit 201 of the management device 20 identifies the storage device 10 that provides the virtual volume 1442 specified by the request for deletion of the virtual volume, with reference to the volume management table 21. The volume management unit 201 of the management device 20 sends the request for deletion of the virtual volume 1442 specified by the request for deletion to the identified storage device 10.

When receiving the request for deletion, the storage device 10 deletes the virtual volume 1442, and sends a notification that deletion is completed to the management device 20. When receiving the completion notification, the volume management unit 201 deletes the record of the specified virtual volume 1442 from the volume management table 21 (S812).

Next, with reference to the volume management table 21, the volume management unit 201 determines whether the virtual volume 1442 that belongs to the pool 143 of the creation source of the deleted virtual volume 1442 (hereinafter, referred to as a pool A) exists (S813). When one or more virtual volumes 1442 that belong to the pool A exist (S813a), the processing goes to S815. When no virtual volume 1442 that belongs to the pool A exists (S813b), the volume management unit 201 sends the request to delete the pool A to the storage device 10 to which the pool A belongs. When receiving a notification that deletion of the virtual volume 1442 for the deletion instruction is completed, the volume management unit 201 deletes the record of the pool A from the pool management table 22 (S814).

At S815, the volume management unit 201 notifies the management client device 40 that deletion of the virtual volume 1442 is successful.

With the above-mentioned processing, the user can delete the specified virtual volume 1442. In addition, when the virtual volume 1442 is deleted, the pool 143 that is not used as the creation source of any virtual volume 1442 is automatically deleted.

### <Maintenance Processing of the Pool With Increase in the Used Amount>

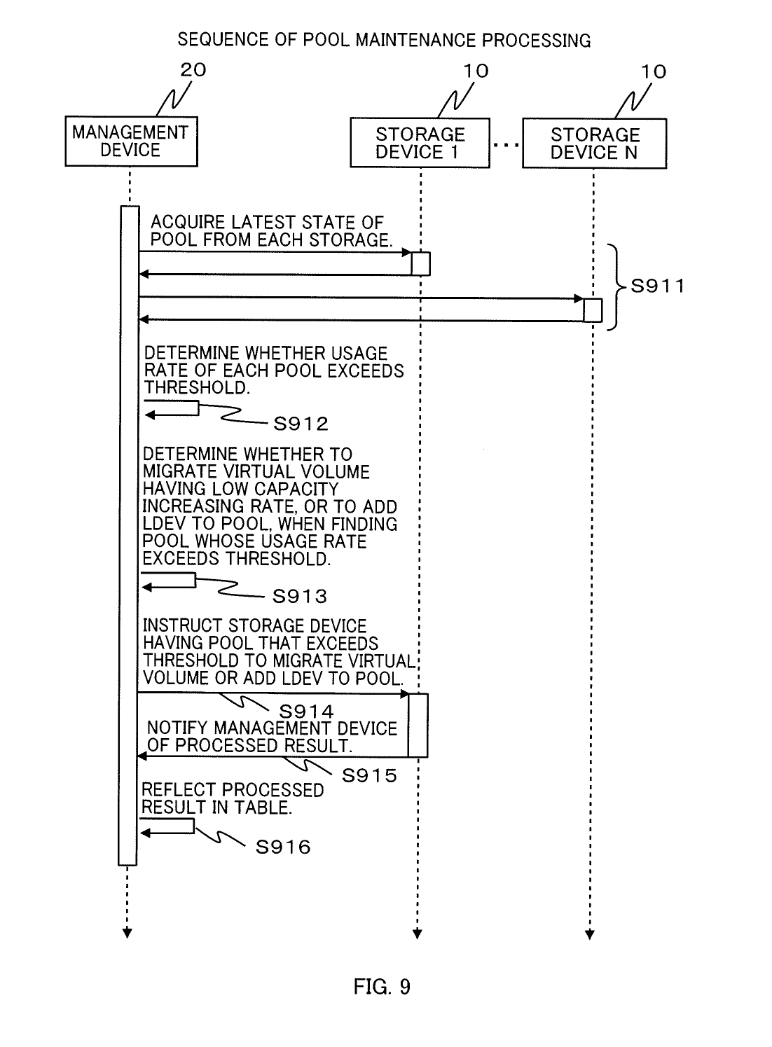

Next, a maintenance processing of the pool 143 with increase in the used amount will be described. FIG. 9 shows a sequence diagram illustrating an outline of the maintenance processing of the pool 143 with increase in the used amount. As shown in the drawing, the pool monitor unit 203 of the management device 20 acquires the information on each pool 143 managed by the storage device 10 of the management target and the use status of the virtual volume 1442 created by each pool 143 (the used amount and usage rate) from the storage device 10 at a predetermined timing (at a periodical or non-periodical timing that is set in advance) (S911). Then, based on the acquired information, the management device 20 determines whether the usage rate of each pool 143 exceeds each threshold 228 set in the pool management table 22 (S912).

When the pool monitor unit 203 finds the pool 143 whose usage rate exceeds the threshold, the pool management unit 202 of the management device 20 determines whether to migrate a predetermined virtual volume 1442 of the pool 143 used as the creation source to other pool 143 having the capacity increasing rate lower than that of the pool 143, or whether to add an unallocated LDEV 142 to the pool 143, to reserve the storage capacity of the pool 143 (to keep usage rate from exceeding the threshold) by using either method of these (S913). Note that, when selecting the former method of migration, it is premised on existence of other pool 143 having the attribute that is common to the pool 143 whose usage rate exceeds the threshold and having a sufficient large unused area (pool 143 having the unused area not smaller than the threshold set in advance). Moreover, the pool management unit 202 grasps the capacity increasing rate with reference to the pool use history management table 23. On the other hand, when selecting the method to add the LDEV 142 to the pool 143, it is premised on existence of an unallocated LDEV 142 as the normal volume 1441 or the virtual volume 1442 that does not cause changes in the attribute of the pool 143 after the addition.

When the pool management unit 202 determines a method for reserving the storage capacity of the pool 143, the pool management unit 202 instructs the storage device 10 to carry out the determined method. The storage device 10 carries out a processing for reserving the storage capacity in response to the above-mentioned instruction (S914). After carrying out the method, the storage device 10 notifies the management device 20 of the processed result (S915). The pool management unit 202 of the management device 20, which has received the processed result, reflects the received processed result in the pool management table 22 (S916).

Note that, when migration is selected as the method for reserving the storage capacity of the pool 143 at S913, an unused storage area of the pool 143 of the creation source of the virtual volume 1442 having the higher capacity increasing rate automatically increases so that the capacity of the virtual volume 1442 having the higher increasing capacity rate can be extended. Therefore, a conventional operation performed when the used amount of the pool 143 exceeds the threshold is omitted, so that operation burden placed on the user is reduced.

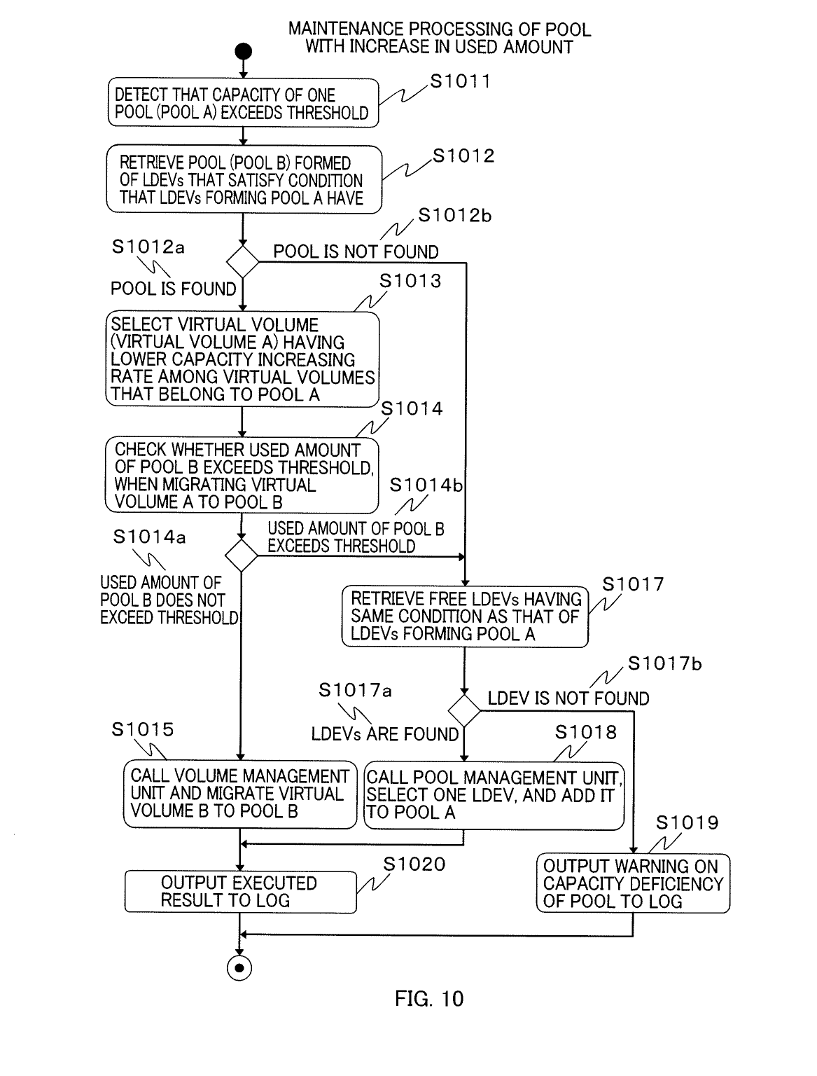

FIG. 10 is a flow chart illustrating details of the processing performed by the management device 20 at the time of the maintenance processing on the pool 143.

When the pool monitor unit 203 of the management device 20 detects that the usage rate of one pool 143 (pool A) exceeds the threshold among the pools 143 registered in the pool management table 22 (S1011), the pool monitor unit 203 of the management device 20 retrieves another pool from the pool management table 22, the pool being the pool 143 formed using the same type of the LDEV 142 as that of the LDEV 142 that forms the pool A, in other words, the pool being other pool 143 (pool B) that satisfies a condition that the pool type of the other pool 143 coincides with the pool type 224 of the pool A, or a condition that the pool type of the other pool 143 includes the pool type 224 of the pool A (S1012).

Note that “the pool 143 formed of the same type of the LDEV 142 as that of the LDEV 142 that forms one pool 143” refers to the pool 143 including only the LDEV 142 having the same attribute as the type has, when the number of types of the LDEVs 142 that form one pool 143 is one, for example, when all the LDEVs 142 that form the pool 143 are “FC” and “RAID5.” Moreover, when a plurality of types of the LDEVs 142 that form one pool 143 exist, the expression above refers to the pool 143 including only the LDEV 142 of the plurality of types. Specifically, for example, when the LDEV 142 included in the pool A has two patterns as a pattern of “FC” and “RAID5” and a pattern of “SATA” and “RAID5,” the expression above corresponds to the pool 143 formed of only the LDEVs of “FC” and “RAID5,” the pool 143 formed of only the LDEVs of “SATA” and “RAID5,” or the pool 143 formed of only the LDEV 142 of the both types.

When the other pool B that satisfies the above-mentioned condition is found (S1012a), the pool monitor unit 203 selects a predetermined number of the virtual volumes 1442 as a target of migration to the pool B (here, the predetermined number is 1 and the virtual volume A is selected), the predetermined number of the virtual volumes 1442 being selected sequentially from the virtual volume 1442 having the lower capacity increasing rate among the virtual volumes 1442 whose creation source is the pool A (S1013).

The pool monitor unit 203 checks whether the used amount of the pool B exceeds the threshold when migrating the virtual volume A to the pool B (S1014). As a result, when the used amount of the pool B does not exceed the threshold (S1014a), the pool monitor unit 203 migrates the virtual volume A to the pool B (S1015). In other words, migration is performed only when it is checked that the used amount of the pool B does not exceed the threshold. After migration, the pool monitor unit 203 updates the information on the virtual volume 1442 for migration to the state after migration in the pool management table 22.

When the other pool B that satisfies the above-mentioned condition is not found at S1012 or S1014 (S1012b, S1014b), the pool monitor unit 203 retrieves an unused LDEV 142 having the same type as that of the LDEV 142 that forms the pool A from the volume management table 21 (S1017). At this time, when the LDEVs 142 of components of the pool A include the LDEVs 142 having different volume types, for example, when the LDEV 142 of “FC” and “RAID5” and the LDEV 142 of “SATA” and “RAID5” are included, either of the LDEVs 142 that satisfies the condition is retrieved.

When the free LDEV 142 having the same condition is found (S1017a), the pool monitor unit 203 sends an instruction to add the found LDEV 142 to the pool A to the storage device 10. When receiving the completion notification from the storage device 10, the pool monitor unit 203 updates the pool management table 22 (S1018). When the LDEV 142 is not found (S1017b), the pool monitor unit 203 outputs a warning on capacity deficiency of the pool 143 to a log, etc. (S1019).

When migration of the virtual volume B can be carried out or the storage capacity of the pool A can be extended, the pool monitor unit 203 outputs the result to the log, etc. (S1020).

When the above-mentioned processing is performed and the usage rate of the pool 143 does not become smaller than the threshold, the above-mentioned processing is repeatedly performed until the usage rate of the pool 143 becomes smaller than the threshold, and migration of the virtual volume 1442 or automatic extension of the pool 143 is repeatedly performed. When automatic extension becomes impossible, the warning on capacity deficiency of the pool 143 is notified.

For example, when the virtual volumes 1442 is grouped in job units or the like from a viewpoint of operation of the system, and it is more preferable to carry out migration of the virtual volume 1442 in groups, migration may be carried out so as not to break down the units of grouping.

Further, when the storage management unit 200 determines the pool 143 used as a migration destination, the storage management unit 200 may check whether the pool 143 satisfies a SLO (Service Level Objective) required of the virtual volume 1442 that is a target of migration, and the storage management unit 200 may preferentially select the pool 143 that satisfies the SLO as the pool 143 of the migration destination.

<When Restrictions of the Pool are Taken into Consideration>

There is a case where the pool 143 provided by the storage device 10 may have restrictions such as the maximum number and the maximum capacity of the LDEVs 142 that can be used as the components of one pool 143. For this reason, when the management device 20 requests the storage device 10 to maintain or migrate the pool 143, the storage device 10 returns an error to the management device 20 due to the above-mentioned restrictions. Hereinafter, a method of a maintenance processing on the pool 143 when taking such restrictions into consideration will be described.

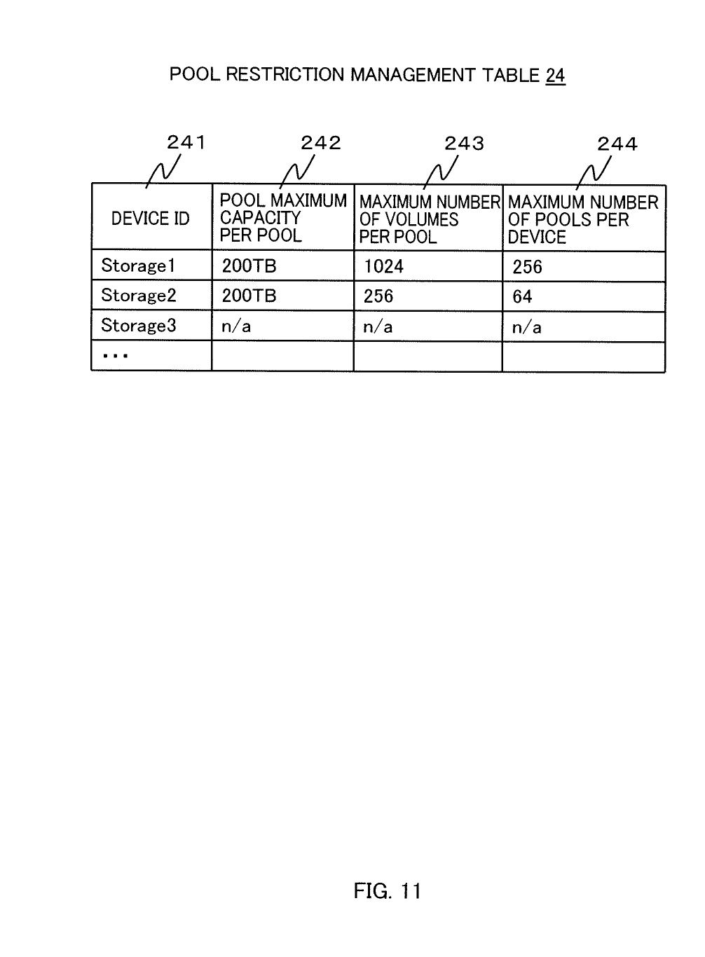

FIG. 11 shows a table managed by the management device 20 for the above-mentioned maintenance processing, in which the restrictions of the pool 143 are managed (hereinafter, referred to as pool restriction management table 24). In the pool restriction management table 24, the restrictions on each pool 143 provided by each storage device 10 are managed. As shown in the drawing, the pool restriction management table 24 has a plurality of records that includes items of the device ID 241, the maximum capacity 242 of the pool 143, the maximum volume number 243 of the pool 143, and the maximum number 244 of the pool 143 that one storage device 10 can possess.

In the device ID 241, the storage ID of the storage device 10 that provides the pool 143 is set. In the pool maximum capacity 242 per pool, the maximum of a total capacity of the LDEVs 142 that can be added to one pool is set. In the maximum volume number 243 per pool, the maximum number of the LDEVs 142 that can be added to one pool 143 is set. In the maximum pool number 244 per device, the maximum number of the pool 143 that the storage device 10 can possess is set.

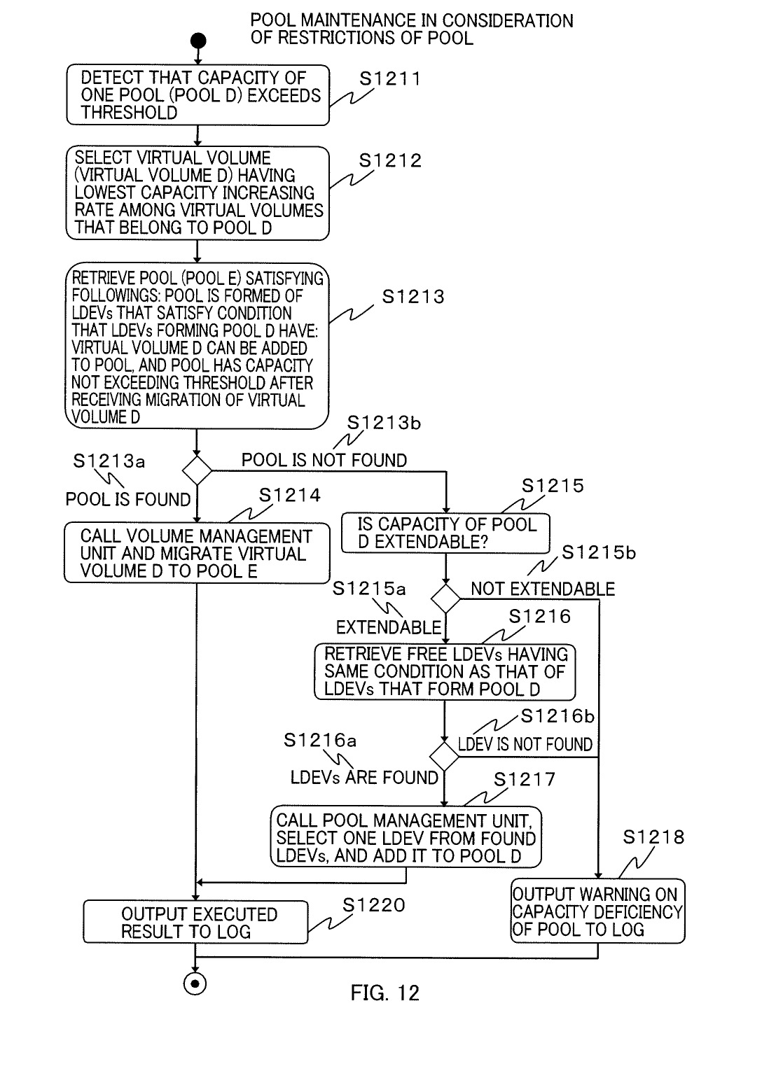

FIG. 12 is a flow chart illustrating the maintenance processing on the pool 143 performed by the management device 20 in consideration of the restrictions of the pool 143.

When the pool monitor unit 203 of the management device 20 detects the pool 143 (pool D) whose usage rate 227 exceeds the alert threshold 228 among the pools 143 registered in the pool management table 22 (S1211), the pool monitor unit 203 of the management device 20 selects a predetermined number of the virtual volume 1442 as a migration candidate of the virtual volumes 1442 whose creation source is the pool D in the pool use history management table 23 (S1212), the predetermined number of the virtual volume 1442 being selected sequentially from the virtual volume 1442 having the lower capacity increasing rate (here, the predetermined number is 1 and the virtual volume D is selected).

With reference to the pool management table 22, the pool monitor unit 203 acquires a list of the pools 143 having the pool type 224 that satisfies the pool type of the pool D (pool list A). Then, the pool monitor unit 203 acquires the device ID (device D) of the pool D from the pool management table 22. With reference to the pool restriction management table 24, the pool monitor unit 203 acquires the maximum capacity 242 per pool 143 of the device D, and the maximum volume number 243 per pool 143. Thereby, the pool monitor unit 203 retrieves the pool 143 to which the virtual volume D can be added from the pool list A (search result is referred to as pool list B). Then, the pool monitor unit 203 retrieves the pool 143 (referred to as pool E) from the pool list B, migration of the virtual volume D to the pool 143 not causing the capacity of the pool E to exceed the threshold of the pool E.

When the pool 143 (pool E) that satisfies the condition is found (S1213a), the pool monitor unit 203 calls the volume management unit 201, migrates the virtual volume ID to the pool E (S1214), and outputs the executed result to the log (S1220). When the pool E that satisfies the condition is not found, with reference to the pool restriction management table 24, the pool monitor unit 203 checks whether the capacity can be added to the pool D (S1215). When the capacity cannot be added to the pool D (S1215b), the pool monitor unit 203 outputs to the log, etc. that capacity deficiency of the pool 143 (pool D) occurs and the capacity of the pool 143 (pool D) exceeds the threshold (S1218). When the capacity can be added to the pool D (S1215a), the pool monitor unit 203 retrieves an unallocated LDEV 142 that meets the pool type of the pool D from the volume management table 21 (S1216).

When such a LDEV 142 is not found (S1216b), the pool monitor unit 203 outputs the log showing that there is no LDEV 142 that can be added while the current pool type is maintained (S1218). When such LDEVs 142 are found (S1216a), the pool monitor unit 203 calls the pool management unit 202, selects one LDEV 142 from the LDEVs 142 found, adds the LDEV to the pool D (S1217), and subsequently, outputs the executed result to the log (S1220).

With the above-mentioned processing, in the management device 20, the instructions to maintain and migrate the pool 143 can be given to the storage device 10 in consideration of the restrictions of the pool 143. With this, before receiving an answer of the error from the storage device 10, proper judgment can be made in the management device 20.

### <Size Reduction of the Pool Having a Larger Unused Area>

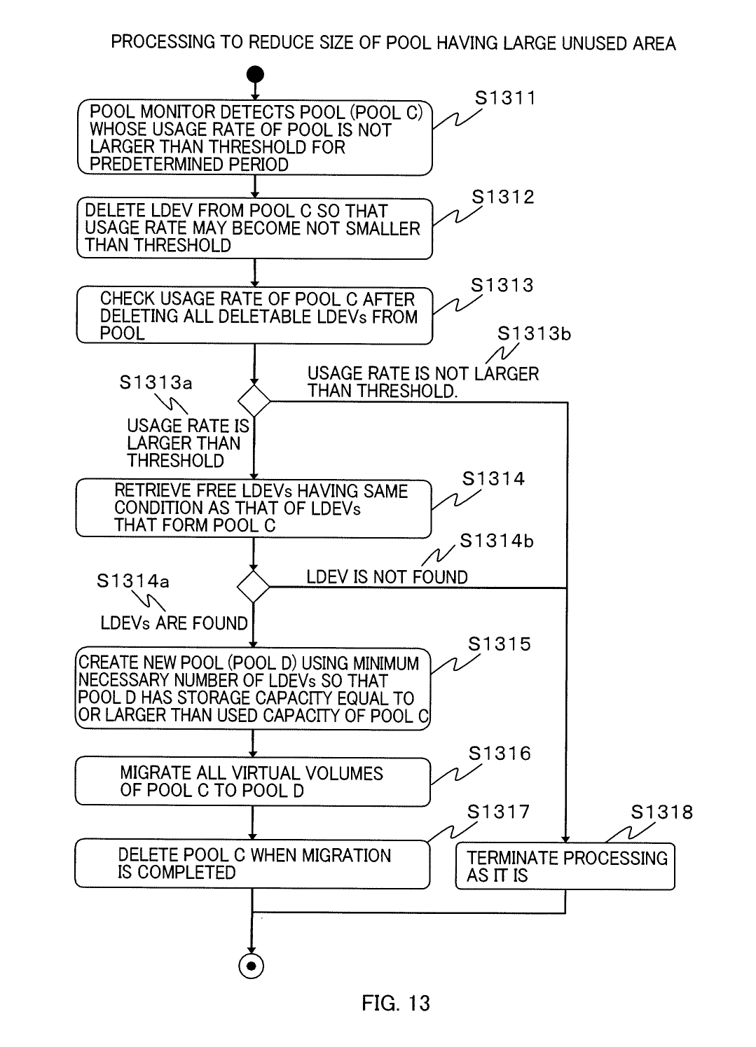

FIG. 13 is a flow chart illustrating a processing to reduce the storage area of the pool 143 having a larger unused area, the processing being performed by the management device 20. In this processing, when the management device 20 detects the pool 143 having the larger unused area (the unused area is not smaller than a predetermined threshold), the management device 20 deletes the LDEV 142, in which the data has not been stored yet, from the pool 143. When the LDEV 142 is deleted and the unused area of the pool 143 is still larger, the management device 20 creates a new pool 143 that stores the data of the pool 143 having the larger unused area, and deletes the old pool 143. When the data of the virtual volume 1442 is already stored in the LDEV 142, the LDEV 142 may be unable to be deleted even when the unused area of the pool 143 is larger. In this case, the pool 143 is re-created.

Note that the pool 143 having the larger unused area is generated: when the pool 143 is extended since the storage capacity of the virtual volume 1442 temporarily increased in the past, and subsequently the storage capacity is reduced; the capacity increasing rate of the virtual volume 1442 is smaller than that scheduled at the beginning, and the pool 143 is out of management by the virtual volume 1442 and is managed by the normal volume 1441; and when the data managed by the virtual volume 1442 is replicated to another storage device 10, and the virtual volume 1442 that has managed the replicated data is deleted from the pool 143.

Hereinafter, a description will be given with reference to FIG. 13. When the pool monitor unit 203 of the management device 20 detects that the usage rate 227 of a pool 143 (pool C) in the pool management table 22 is not larger than the alert threshold 228 (S1311), the pool monitor unit 203 of the management device 20 selects the LDEV 142 that can be removed (deleted) from the components of the pool C among the LDEVs 142 that form the pool C, and sends an instruction to remove (delete) the selected LDEV 142 from the components of the pool C to the storage controller 101 of the storage device 10 (S1312).

Note that, whether the LDEV 142 can be deleted from the pool C in the above-mentioned selection may be determined on the management device 20 side, or may be determined on the storage device 10 side. A criterion of determination at this time is, for example, whether the data of the virtual volume 1442 is recorded on the LDEV 142.

When deletion of the LDEV 142 that can be deleted in the storage device 10 is completed, the pool monitor unit 203 checks the usage rate of the pool C again (S1313). As a result of checking, when the usage rate 227 is not larger than the alert threshold 228 (S1313b), the pool monitor unit 203 terminates the processing (S1318).

On the other hand, when the usage rate 227 of the pool C exceeds the alert threshold 228 even after the LDEV 142 that can be deleted is deleted from the pool 143 (S1313a), the pool monitor unit 203 retrieves the unused LDEVs 142 of the same type as that of the LDEV 142 included in the pool C from the volume management table 21. Then, the pool monitor unit 203 checks that a total capacity of the retrieved unused LDEVs 142 is not smaller than the used amount 226 of the pool C in units of each storage device 10 (S1314). In the present embodiment, since it is premised that one pool 143 cannot be created across a plurality of storage devices 10, the storage capacity is checked for each storage device 10.

When the total capacity of the LDEV 142 is not smaller than the used amount of the pool C (S1314a), the pool monitor unit 203 selects a minimum necessary number of unused LDEVs 142 and creates a new pool (pool D) (S1315). Here, the minimum necessary number of unused LDEVs 142 are selected so as to have the minimum storage capacity equal to or larger than the used amount of the pool C, that is, so as to satisfy the condition required of the virtual volume 1442 to which migration is performed. For example, in a case where the storage capacity of one LDEV 142 has 10 GB, when the used amount of the pool C is 1 GB, only one unused LDEV 142 is selected, and when the used amount of the pool C is 15 GB, two unused LDEVs 142 are selected.

Alternatively, the pool monitor unit 203 may create the new pool 143 by using only the storage resource (LDEV 142) to be determined based on the capacity increasing rate of the virtual volume 1442 that is the target of migration. For example, when it is expected that the used amount of the pool 143 exceeds the threshold within a predetermined period of time set in advance, only the storage resource needed after the predetermined period of time is allocated.

Thereby, unnecessary consumption of the storage resource can be prevented and the unused storage resource can be reserved.

When creation of the new pool 143 is completed, all the virtual volumes 1442 whose creation source is the pool C are migrated to the pool D (S1316), and the pool C is deleted after completion of migration (S1317). Note that the pool monitor unit 203 reflects results of addition of the pool D and deletion of the pool C in the pool management table 22.

When the total capacity of the LDEVs 142 is smaller than the used amount of the pool C at S1314 (S1314b), the processing is terminated as it is since the virtual volume 1442 cannot be migrated (S1318).

In the above-mentioned processing, migration is carried out by creating the pool 143 formed of the LDEV 142 of the same type as that of the migration source for the migration destination of the virtual volume 1442. Alternatively, the virtual volume 1442 may be temporarily migrated to any other logical volume, the original pool 143 may be re-created, and the virtual volume 1442 may be migrated to the re-created pool 143. Thereby, even when the LDEV 142 of the same type as that of the migration source does not exist, the size of the pool 143 can be reduced.

With the above-mentioned processing, since the storage capacity of the pool 143 whose unused area has been larger due to various causes is automatically reduced, a free storage area can be reserved for the storage device 10. Accordingly, the storage resource can be effectively utilized.

As a summary of the embodiments described above, the user operates the virtual volume 1442 without directly managing the use status of the pool 143 of the creation source of the virtual volume 1442, the configuration of the pool 143, etc. Additionally, complicated management concerning the virtual volume 1442 can be reduced.

While preferable embodiments of the present invention have been described as mentioned above, these are exemplification for description of the present invention, and will not limit the scope of the present invention only to the embodiments. The present invention can be implemented in other various forms. For example, while a smallest unit of the logical storage area is the LDEV in the above-mentioned description, the smallest unit of the storage area will not be limited to this.

What is claimed is:

1. A management device coupled to a storage device that provides a virtual volume using one storage pool of a plurality of storage pools as a creation source, comprising:
a memory storing pool management information; and
a CPU setting the plurality of thresholds of the plurality of storage pools to the pool management information,
wherein the management device detects that a used amount of a certain one of the storage pools exceeds a certain threshold which is one of the plurality of the thresholds and corresponds to the certain storage pool,
wherein the management device identifies a predetermined number of the virtual volumes sequentially selected in ascending order of capacity increasing rate which are migrated to another one of the storage pools that is different from the certain storage pool using as a creation source, and
wherein the management device sends a migration instruction to the storage device indicating the certain storage pool and the predetermined number of the virtual volumes.

2. The management device according to claim 1, wherein the management device selects the storage pool that satisfies a predetermined condition as the other storage pool.

3. The management device according to claim 2, wherein the predetermined condition is a condition that the storage pool has an attribute of a storage resource identical to that of the certain storage pool currently used as the creation source for the virtual volume to be migrated.

4. The management device according to claim 3,
wherein the storage resource is a physical disk, and
wherein the attribute is at least any one of a type of an interface that the physical disk has, a level of RAID formed by the physical disk, a storage capacity of the physical disk, performance of the physical disk, and a model number of the physical disk.

5. The management device according to claim 2, wherein the predetermined condition is a condition that the storage pool has the used amount not exceeding a threshold set in advance after executing the migration.

6. The management device according to claim 2, wherein the predetermined condition is a condition that the storage pool satisfies a Service Level Objective (SLO) required of the virtual volume to be migrated.

7. The management device according to claim 2,
wherein in case that none of the other storage pools satisfies the predetermined condition, the storage management unit newly creates a storage pool that satisfies the predetermined condition and uses the created new storage pool as the other storage pool.

8. The management device according to claim 7, wherein the storage management unit creates the new storage pool using only a minimum storage resource necessary to satisfy the predetermined condition.

9. The management device according to claim 7, wherein the storage management unit creates the new storage pool using only the storage resource of a number or capacity determined based on the capacity increasing rate of the virtual volume to be migrated.

10. The management device according to claim 1, wherein the storage management unit sends the instruction to the storage device in case that the instruction is within a range of a restriction imposed on the storage pool in the storage device.

11. The management device according to claim 10, wherein the restriction is a maximum number or maximum capacity of storage resources usable by one of the storage pools as a component.

12. The management device according to claim 10, wherein the restriction is a number of the storage pools that the storage device is able to possess.

13. A storage system comprising:
a storage device that provides a virtual volume using one storage pool of a plurality of storage pools as a creation source; and
a management computer coupled to the storage device,
wherein the management device sends a migration instruction to the storage device in case that a used amount of a certain one of the storage pools exceeds a threshold set in the certain storage pool in such a manner that a predetermined number of the virtual volumes sequentially selected in ascending order of capacity increasing rate are migrated to another one of the storage pools that is different from the certain storage pool using as a creation source,
wherein the management device uses, as the other storage pool, a storage pool that is formed of a storage resource whose attribute is identical to that of the certain storage pool currently used as the creation source for the virtual volume to be migrated, and that satisfies a condition that the used amount of the storage pool does not exceed a threshold set in advance after executing the migration,
wherein, in case that none of the other storage pools satisfies the condition, the management device newly creates a storage pool satisfying the condition and uses the created new storage pool as the other storage pool, and
wherein the management device sends the instruction to the storage device in case that the instruction is within the range of a restriction imposed on the storage pool in the storage device.
